(19) United States
(12) Patent Application Publication
(10) Pub. No.: US 2005/0246832 A1
(43) Pub. Date: Nov. 10, 2005

(54) Sanitary washing unit and sanitary outlet armature

(75) Inventors: Uwe Zoller, Mullheim (DE); Christoph Weis, Mullheim (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Neoperl GmbH, Mullheim (DE)

(21) Appl. No.: 11/119,863

(22) Filed: May 2, 2005

(30) Foreign Application Priority Data
May 5, 2004 (DE) 102004022513.3-25

(51) Int. Cl. A47K 1/04

(52) U.S. Cl. 4/619

(57) ABSTRACT

A sanitary washing unit (1) having a hand washing basin (1) and at least one sanitary outlet armature (3). The sanitary outlet armature (3) has at least two spaced apart outlet openings (4) to produce visually separated outward flowing water streams (5). The washing unit (1) of the invention has the feature that the longitudinal axes of the outlet openings (4) that determine outflow direction of the water streams (5) are arranged at such an angle that adjacent water streams (5) overlap at least in sections in the atmospheric area between the outlet opening (4) and the impact zone of the water streams (5) in the wash basin (2) or that the distance between the water streams increases. The risk of excessive splashing in the wash basin area is considerably reduced by the washing unit (1).

### BACKGROUND

The invention relates to a sanitary washing unit comprised of a hand washing basin and at least one sanitary outlet armature, and the sanitary outlet armature has at least two outlet openings at a distance from each other to produce water streams that flow out, visibly separate from each other.

Such sanitary washing units must also increasingly justify high aesthetic requirements. A sanitary washing unit was therefore also previously produced that has several outlet openings on its outlet armature. These outlet openings are spaced apart from each other in such a manner that water streams are produced that flow out and meet each other parallel visually separate until they meet in the wash basin. The currents that are produced when these water streams arrive in the wash basin and which are partially aligned in opposite directions affect each other so that the water tends to splash there considerably. However, not only the user controlling the washing unit becomes wet when the water sprays excessively, but this splashing is also distributed over large surfaces in the wash basin and leads to undesirable calcium residue and an increased cleaning effort after drying.

### SUMMARY

It is therefore the objective to produce a sanitary washing unit of the initially described type, which considerably reduces the risk of any excessive water splashing in the wash basin area.

The solution to this objective according to the invention is that the longitudinal axes defining the outflow direction of the water streams are arranged at such angles that adjacent water streams overlap at least in sections in the atmospheric range between the outlet opening and the impact zone of the water streams in the washing basin or that their distance from each other increases.

The longitudinal axes of the washing unit that define the outlet direction of the water streams may be inclined toward each other at an angle so that the initially visually separately outward flowing water streams overlap each other at least in sections in the atmospheric area between the outlet opening including the impact zone in the wash basin. Strong and opposing water flows are prevented by overlapping of the water streams in the impact zone, which otherwise would become noticeable by strong whirling and by splashing. If the longitudinal axes of the outlet openings are relatively inclined toward each other so that the distance of the water streams increases in the atmospheric area, the water flows developing in the impact zone of the wash basin also have an angle so that water flowing in the opposite direction is reduced and whirling and splashing is prevented accordingly.

It is possible that the outlet armature has more than three outlet openings, of which the longitudinal axes of at least two outlet openings are relatively inclined toward each other so that their water streams at least overlap within the atmospheric range and from which the longitudinal axes of the outer outlet armatures are inclined toward each other so that the distance of their water streams to the adjacent water streams is increased in the atmospheric range. If the outlet armature, for example, has four visibly separately outpouring water streams, the two inner water streams may unite to one water stream on their way to the wash basin or only in the impact zone, while the two outer water streams flow out at an angle, which increases in distance to the neighboring water stream. This example shows that especially attractive stream patterns may be produced by outlet openings by using the washing unit according to the invention.

An embodiment is preferred in which the longitudinal axes of the outlet openings are relatively inclined so toward each other that either their water streams overlap in the atmospheric area at least in sections or that the distance of the water streams increases.

An especially beneficial further development of the invention provides that the longitudinal axes of the outlet openings are inclined relatively toward each other in such a manner that their water streams overlap at least in sections, but preferably overlap essentially in the impact zone. This design format is distinguished by an especially high effectiveness and a simultaneously aesthetically desirable stream pattern.

In order to be able to emit a homogenous-soft and always non-splashing water stream, it is beneficial if the outlet openings always have a ventilated or unventilated stream regulator.

It is effective, if the outlet openings are arranged parallel in sequence and/or outline an angular, circular or circle segmented outer contour. The outlet openings of the sanitary outlet armature may not only be arranged parallel and sequential, but these outlet openings may also be arranged parallel so that they jointly outline a corner, such as a square or multi-angular outer contour.

If the outlet openings are arranged in sequence, it is beneficial if the longitudinal axes of the openings that are arranged parallel in sequence are arranged relatively, so that their water streams are approximately in one plane in the atmospheric range.

### BRIEF DESCRIPTION OF THE DRAWINGS

Additional characteristics of the invention result from the following description of the exemplary embodiments of the invention in the drawings in conjunction with the claims. Individual characteristics may be represented individually or combined in one design of the invention.

Sectional detailed perspective views show the following:

FIG. 1 is a view of a sanitary washing unit whose outlet armature has four outlet-openings to produce visibly separate outward flowing water streams, whereby the longitudinal axes of the outlet openings are arranged at an angle so that the distance of the water streams increases on their way from the outlet openings to the impact zone in the wash basin,

FIG. 2 is a view of a sanitary washing unit, in which the longitudinal axes are arranged at an angle so that the adjacent water streams essentially over-lap in the impact zone, and

FIG. 3 is a view showing a sanitary washing unit in accordance with the state of the art with four outlet openings, which produces four parallel outward flowing water streams.

### DETAILED DESCRIPTION OF THE PREFERRED EMBODIMENTS

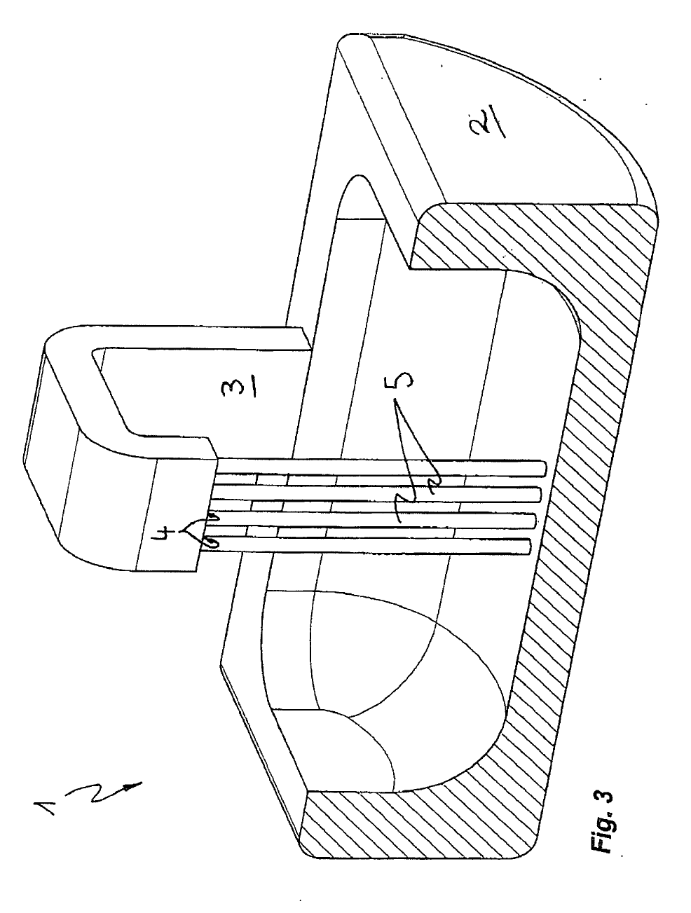

FIG. 3 shows a sanitary washing unit 1 in a sectional detailed perspective view in accordance with the known state of the art. The washing unit 1 has a hand washing basin 2 and a sanitary outlet armature 3. FIG. 3 clarifies that the outlet armature 3 has four outlet openings 4 which are spaced apart from each other, which produce a total of four visibly separate outward flowing water streams 5. These four water streams 5 flow out parallel to each other to meet in an impact zone in hand washing basin 2 after crossing the atmospheric area between the outlet openings 4 and the wash basin 2. After impacting on the impact zone located inside the interior of the hand washing basin 2, the water streams 5 are diverted into a radial outward direction that follows the inner contour of the hand washing basin 2. The flow of adjacent water streams 5 are thereby guided into such opposing directions that they form a wave-projecting whirlpool when impacting against each other. However, not only does the user operating the washing unit become wet from the excessively splashing of the water, but the splashing water distributes over large surfaces of the wash basin 2 and lead to increased cleaning actions after drying, due to undesirable calcium residue.

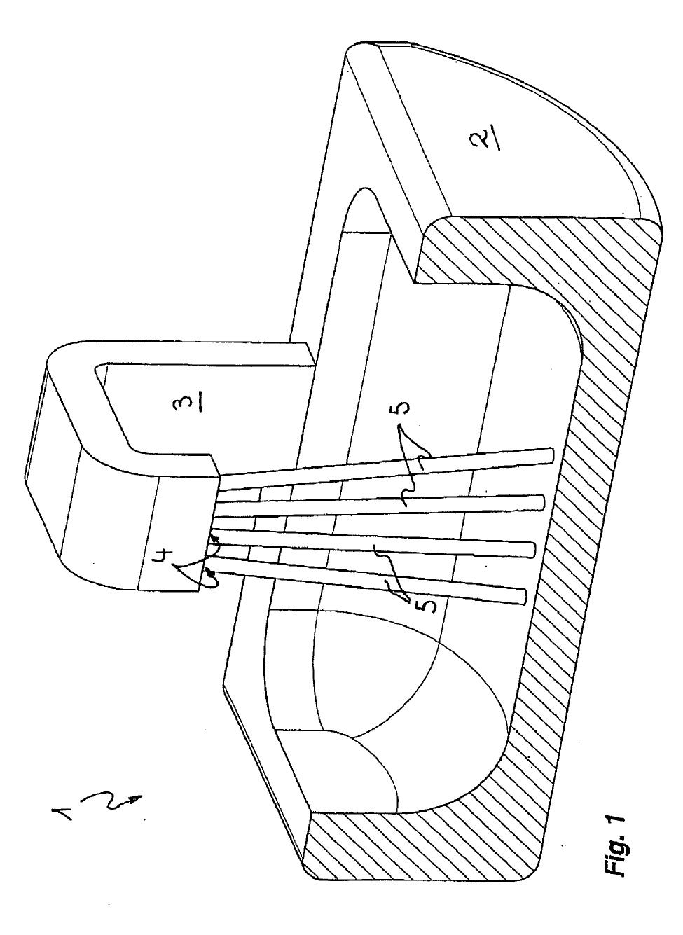

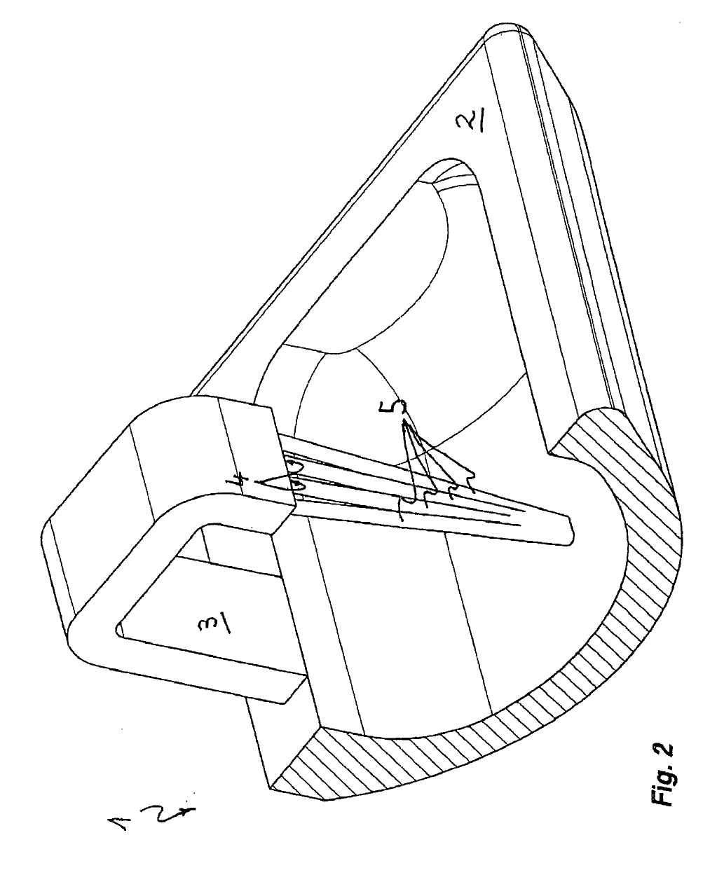

In order to prevent water from excessively splashing in the wash basin area, the longitudinal axes of the outlet openings 4 that define the outflow direction of the water streams 5 are arranged at an angle in the washing units 1 illustrated in FIGS. 1 and 2 that show a hand washing sink 2 and a sanitary outlet armature.

The longitudinal axes of the outlet openings 4 of the outlet armature 3 illustrated in FIG. 1 are designed at an angle so that the distance of the water streams 5 increases from the outlet openings 4 to the impact zone in the wash basin. Since the distance of the water streams continuously increases in the atmospheric area, the water flow developing in the wash basin also have an angle in the impact zone of the wash basin, so that water flowing in the opposite direction is reduced and related whirlpooling and splashing is prevented. Since the distance of the water streams increases in the atmospheric area, the distance of the outlet openings may be kept at a minimum and the outlet armatures may be designed compact. Contouring the wash basin to reduce splashing in the impact zone is also dispensable without expecting excessively much splashing.

In contrast, the longitudinal axes of outlet openings 4 of the outlet armature shown in FIG. 2 are located at such an angle that the neighboring water streams 5 at least overlap in the atmospheric area between the outlet opening 4 and the impact zone of the water streams in the wash basin, at least partially. Two strong and opposing water currents are prevented by overlapping the water streams in the outlet armature shown in FIG. 2, which otherwise would become noticeable by strong swirling and by developing splashes. The longitudinal axes of the outlet openings 4 shown in the example in FIG. 2 are relatively angled toward each other so that their water streams 5 essentially overlap directly prior to impacting the impact zone in the hand washing sink 2.

The outlet armatures 3 shown in FIGS. 1 and 2 may have a disk-shaped stream forming elements in the outlet openings 4. So that always a homogenous-soft and also non-splashing water stream 5 flows from the outlet openings 4, it is logical, if the outlet openings 4 always have a ventilated or unventilated stream regulator. All outlet openings 4 of a sanitary outlet armature can either have a ventilated or an unventilated stream regulator; however, it is also possible that at least one outlet opening of a sanitary outlet armature has a ventilated stream regulator, while the remaining outlet openings of this outlet armature have unventilated stream regulators. The outlet openings 4 in FIGS. 1 and 2 are arranged angular in sequence so that their water streams 5 are located approximately in one plane in the atmospheric area.

The washing units shown in FIGS. 1 and 2 are distinguished by an aesthetically attractive streaming pattern that also considerably reduces the risk of excessive splashing in the area of the wash basin.

1. Sanitary washing unit (1) comprising a hand washing basin (2) and at least one sanitary outlet armature (3), the outlet armature (3) has at least two outlet openings (4) that are spaced apart from one another to produce visually separate outward flowing water streams (5), an outflow direction defined by longitudinal axes of the outlet openings (4) that define the outflow direction of the water streams (5) are located at an angle from each other so that adjacent ones of the water streams (5) overlap in an atmospheric area between the outlet opening (4) and an impact zone of the water streams (5) in the wash basin (2), at least in sections, or a distance between the water streams increases to prevent water from splashing in an area of the wash basin.

2. Washing unit according to claim 1, wherein the outlet armature (3) has more than three of the outlet openings (4), from which the longitudinal axes of at least two outlet openings (4) are angled toward each other relatively so that the water streams (5) flowing therefrom overlap in the atmospheric area, and the longitudinal axes of outer ones of the outlet openings (4) are angled so that a distance between the water streams flowing therefrom in the atmospheric area increases.

3. Washing unit according to claim 1, wherein the longitudinal axes of the outlet openings (4) are angled so that either the water streams (5) overlap at least in sections in the atmospheric area or that the distance between the water streams (5) increases.

4. Washing unit according to claim 3, wherein the longitudinal axes of the outlet openings (4) are angled toward each other relatively so that the water streams (5) completely overlap in the area of the impact zone.

5. Washing unit according to claim 1, wherein the outlet openings (4) have at least one ventilated or unventilated stream regulator.

6. Washing unit according to claim 5, wherein the outlet openings (5) each have a ventilated or an unventilated stream regulator.

7. Washing unit according to claim 5, wherein at least one of the outlet openings of the sanitary outlet armature has a ventilated stream regulator and that unventilated stream regulators are provided in the remaining outlet openings of the sanitary outlet armature.

8. Washing unit according to claim 1, wherein the outlet openings (4) are arranged sequentially and/or outline an angular, circular or circle segmented outer contour.

9. Washing unit according to claim 8, wherein the longitudinal axes of the sequentially arranged outlet openings (4) are arranged relatively so that the water streams are located approximately in one plane in the atmospheric area.

10. Sanitary outlet armature for use in the sanitary washing unit according to claim 1.
